(19) United States
(12) Patent Application Publication
(10) Pub. No.: US 2015/0197061 A1
(43) Pub. Date: Jul. 16, 2015

(54) CUSTOMIZED LASER METAL POWDER 3D PRINTED CONSUMABLE WELD INSERTS

(71) Applicant: Caterpillar Inc., Peoria, IL (US)

(72) Inventors: Huijun Wang, Peoria, IL (US); Lingyun Pan, Dunlap, IL (US); Donald A. Stickel, III, Chillicothe, IL (US); James A. Forck, Peoria, IL (US); Howard W. Ludewig, Groveland, IL (US)

(73) Assignee: Caterpillar Inc., Peoria, IL (US)

(21) Appl. No.: 14/155,888

(22) Filed: Jan. 15, 2014

(51) Int. Cl. B29C 67/00; G05B 15/02; G06F 17/50; B23K 15/00; B23K 26/34

(52) U.S. Cl. CPC B29C 67/0088; B23K 15/0086; B23K 26/345; G06F 17/50; G05B 15/02; B33Y 50/02

(57) ABSTRACT

High weld fatigue class transverse butt joint welds utilizing customized consumable weld inserts laid into the root of the joint. The customized consumable weld inserts may be produced with a 3D printer using digital data obtained by scanning of the joint or from product specifications. The insert may be printed or formed using one or more metal powders that may be solidified by the 3D printer.

### BACKGROUND

1. Technical Field

Disclosed herein are methods of generating customized three-dimensional consumable weld inserts for butt joints. The disclosed methods customized weld inserts account for joint irregularities.

2. Description of the Related Art

Welding is one process for joining two or more base metal parts, for example, two structural steel parts. Welding may be preferred over the use of bolts, although welding is slower than the use of bolts. Welding typically includes the use of a filler material, the choice of which is made based on the particular base metal that is being welded. A properly welded joint is stronger than the base metal plates that are joined by the weld. The strength of a weld, however, depends upon the base metal, the filler, the throat or depth of the weld and the width of the weld.

Gas metal arc welding (GMAW) involves the use of a metal electrode in the form of a wire continuously fed to a welding gun. The wire is fabricated from a filler material. The welding gun is connected to an inert gas supply. The base metal serves as the other electrode. An electric potential is applied between the wire and base metal, which causes the wire to melt. The gas flows through an annular space around the wire and provides a shield that protects the molten wire or filler metal and the welding puddle from the atmosphere. Some welds require only a single pass of the wire electrode along the joint; larger welds may require multiple passes to complete the weld. Gas tungsten arc welding (GTAW) is similar to GMAW, but the welding gun includes a non-consumable tungsten electrode and the use of a separate filler rod that melts and forms the weld with the two base metal parts.

One structural joint between two base metal parts that lie in the same plane is known as a butt joint, which is a type of groove joint. Butt joints are known as full penetration welds because the weld extends across the full cross-section of the two base metal parts being joined. Several techniques exist for welding butt joints that have tight tolerances. One technique is to utilize a metallic backing strip, such as a steel backing strip located on a side of the joint opposite the weld. The backing strip provides a surface for depositing and containing molten filler metal to prevent molten filler metal from escaping through a backside of the joint. Weld backing strips are particularly useful for full penetration welds, e.g., butt joint welds. During the welding process, the metallic backing strip fuses into the joint and ends up being part of the welded structure. The metallic backing strip increases the mass of the welded product and typically creates gaps between the backing strip and the joint and/or the welded product. These gaps may collect moisture, which may lead to corrosion. More importantly, the backing strip technique produces a joint that has a low fatigue class rating (F) due to inherent stress risers in the finished product. Still further, backing strips can't be used when the welder has no access to the backside of the joint, which is a common predicament.

A butt joint with a higher fatigue class rating may be achieved by using consumable inserts. A consumable insert is strip of filler material having a specific cross-sectional shape. The consumable insert is placed at root of the groove, or the narrowest part of the joint, i.e., the narrowest gap between the two base metal parts. At first, the consumable insert offers a backing such as that provided by the metal backing strip described above, but as the weld progresses, the consumable insert melts into the weld and solidifies. When the filler material of the consumable insert melts, surface tension helps to prevent the molten filler material from escaping through the backside of the joint. In contrast to the use of a backing strip, the use of a consumable insert produces a finished product with less excess mass and the weld does not requisitely end up with an increased thickness. Further, eliminating the backing strip results in a weld with a higher fatigue class rating than that produced with a metal backing strip. Presently, consumable inserts are provided with standard “A” shaped and “Y” shaped cross-sections. The use of “A” shaped consumable inserts requires access to the backside of the joint while the use of “Y” shaped consumable inserts does not. This disclosure is directed to the use of “Y” shaped consumable inserts, or inserts that do not require access to the backside of the joint.

However, consumable inserts have consistent cross sections, while butt joints (and groove joints for that matter) may not have consistent cross sections. Specifically, the root, or narrowest portion of the joint may be smaller at some point along the weld and larger at others. Further, throat or thickness of the joint may vary, especially if the two base metal parts or plates are not perfectly coplanar, which is often the case. Finally, while consumable inserts may provide a higher fatigue class of butt joint verses a butt joint formed using a metal backing strip, methods of forming even higher rated butt joints are needed.

Thus, there is a need for improved methods of welding butt or groove joints that avoid the use of metal backing strips in favor of “Y” shaped consumable inserts or inserts that do not require access to the backside of the butt joint. Further, there is a need for improved, full penetration butt joints that have a higher fatigue class rating than welded butt joints formed by using metal backing strips, “A” shaped consumable inserts, or conventional “Y” shaped consumable inserts that have consistent cross sections.

### SUMMARY OF THE DISCLOSURE

In one aspect, a method of fabricating a customized consumable weld insert is disclosed. The disclosed method may include providing two base metal parts. Each base metal part may have at least one edge. The method may further include arranging the two base metal parts in an edge to edge configuration with a groove disposed between the two edges. The groove may include at least one variation along the groove. The method may further include scanning the groove to provide digital data regarding three-dimensional (3D) shapes and sizes of the groove and the at least one variation along the groove. The method may further include converting the digital data into a 3D model and transmitting the 3D model to a 3D printer. The method may further include printing the customized consumable insert from metal powder using the 3D printer.

In another aspect, a method of joining two base metal parts at a butt joint is disclosed. The method may include aligning the two base metal part in a coplanar fashion wherein edges of the two base metal part face each other and form a groove between the edges. The groove may be non-uniform in cross-section along the groove and may include at least one variation. The method may further include scanning the groove with a scanner to provide digital data and converting the digital data to a three-dimensional (3D) model of the groove. The method may further include transmitting the 3D model to a 3D printer. The method may further include printing the customized consumable insert from metal powder using the 3D printer, wherein the insert is based on the 3D model. The method may further include placing the insert in the groove and welding the two base plates together at the groove to form a butt weld wherein the insert forms part of the butt weld.

In yet another aspect, a customized consumable weld insert is disclosed for joining two base metal parts at a butt weld. The disclosed insert may include two legs, wherein each leg may include a distal end that leads to a proximal end. The proximal ends of the legs may be joined together at a central portion. The central portion may be disposed between and connected to the proximate ends of the legs and a root filler portion. The root filler portion may extend away from the central portion and the two legs and may terminate at a proximate end. The insert may have a generally Y-shaped cross-sectional profile along the insert and at least one cross-sectional dimension of the insert may vary along the insert. The at least one cross-sectional dimension may be selected from the group consisting of a distance (D) between the distal ends of the legs, a height (H) between the distal ends of the legs and the proximate end of the root filler portion, and a maximum width (W) of the root filler portion.

Other advantages and features will be apparent from the following detailed description when read in conjunction with the attached drawings.

### BRIEF DESCRIPTION OF THE DRAWINGS

For a more complete understanding of the disclosed methods and weld inserts, reference should be made to the embodiment illustrated in greater detail on the accompanying drawings, wherein:

FIG. 1 is a sectional view of a Y-shaped consumable weld insert.

FIG. 2 is a sectional view of a Y-shaped consumable insert disposed in a groove of a butt joint disposed between two base metal parts prior to welding.

FIG. 3 is a sectional view illustrating a disclosed customized Y-shaped consumable weld insert disposed in a groove of a butt joint disposed between two base metal parts, wherein the base metal parts are not perfectly coplanar thereby creating variations in the groove.

FIG. 4 is a schematic illustration of a disclosed process for scanning a joint that needs to be welded to create a 3D model of the joint and a 3D model of a consumable insert based on the 3D model of the joint, printing the 3D model of the consumable insert and welding the joint using the printed consumable insert.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

Consumable weld inserts come in a variety of sizes, but the cross-sectional dimensions of currently available weld inserts are uniform along the length of the insert. One problem addressed herein is that currently available consumable weld inserts may cease to offer weld fatigue class improvement when there is one or more variations in the cross sectional shape or size of the weld groove, i.e., variations in the spacing or alignment between the two base metal parts to be connected. This is especially true if there is misalignment between the ends or butts of the two base metal parts, which is often the case. Further, it is hard to fuse the consumable insert completely and consistently with gas metal arc welding (GMAW) or gas tungsten arc welding (GTAW) when the joint has a varying cross-section. Also, there may be undesirable mass and thickness left over after the welding process when the joint cross-section varies in size and/or shape. Specifically, the weld may be too large for narrower or smaller areas of the joint or too small for larger or wider areas of the joint. In certain welding techniques, it is simply impossible to get a tight joint variation or a uniform joint cross-section that may be required when standard, uniform “Y” shaped consumable inserts are employed.

The disclosed methods include the fabrication and use of a customized consumable insert using three-dimensional (3D) printing. 3D printing is a technology wherein a metal powder may be applied in layers and solidified and secured to previous layers using a laser. The resultant shape of the solidified metal may be determined by digital data or product specifications that are provided to the 3D printer.

In one aspect, the weld joint may be laser scanned to produce digital data regarding the shape of the weld joint, including variations in the shape. The digital data may be converted to a three-dimensional model using software, as will be apparent to those skilled in the art. The 3D model is transmitted to a 3D printer, which may slice that model into single layer thicknesses and one layer may be formed at a time and solidified with a laser to print a customized consumable weld insert. In certain refinements, the scanning and printing may be performed at the welding facility. The customized consumable weld insert may be composed of metal filler powder that is solidified by the 3D printer. An advantage of this technique is that the disclosed customized consumable weld inserts can tolerate more misalignment variations and more root opening variations than conventional, prefabricated consumable weld inserts.

The 3D printed customized consumable weld inserts may provide a high fatigue class (D) rating due to fewer stress risers and defects that result from the use of uniform, conventional consumable inserts. Further, without a metal backing strip, the thickness of the weld joint may be reduced, along with weight and product cost reductions.

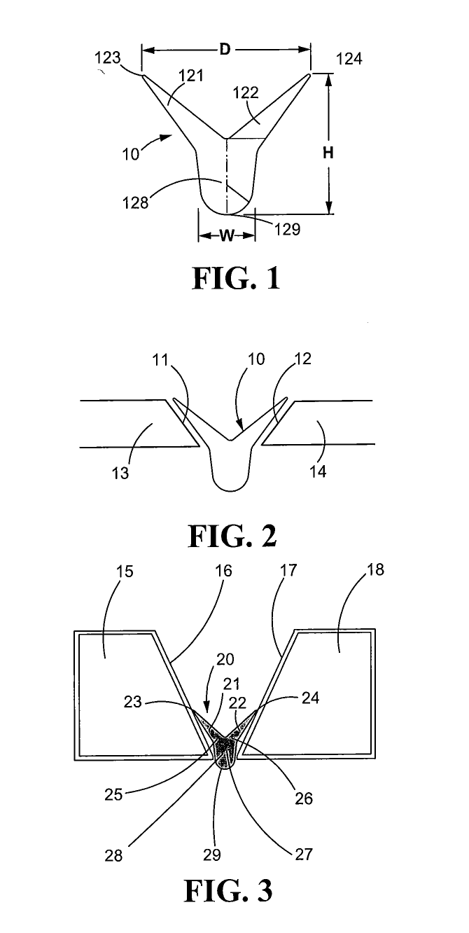

FIGS. 1-3 illustrate the problem addressed by the disclosed customized consumable weld inserts, the disclosed methods of fabricating customized consumable weld inserts and the disclosed welding methods. Specifically, referring to FIG. 1, a standard Y-shaped consumable weld insert 10 is illustrated. The insert 10 includes two legs 121, 122 that have distal ends 123, 124 that are spaced-apart by a distance D, a root filler portion 128 that has a width W and a height H between the distal ends 123, 124 of the legs and the proximal end 129 of the root filler portion 128. The reader will note that FIG. 1 is a cross sectional view of the insert 10 and currently available weld inserts have a consistent cross section along the length of the insert. This is illustrated in FIG. 2 wherein the insert 10 is disposed in a groove defined by the edges 11, 12 of the base metal parts 13, 14 that will be joined by a butt weld. The reader will note that the base metal parts 13, 14 are coplanar and therefore the groove between the edges 11, 12 is consistent in shape and size along the length of the joint.

In contrast, FIG. 3 illustrates two base metal parts 15, 18 that are to be joined by a butt weld. However, the base metal parts 15, 18 are not perfectly coplanar and, in fact, are offset from one another. Thus, the groove formed between the edges 16, 17 of the base metal parts 15, 18 does not have a consistent cross sectional size or shape. Thus, a consumable weld insert that has a uniform cross-sectional shape along the length of the insert cannot provide a butt weld with a high fatigue class rating for the base metal parts 15, 18 shown in FIG. 3. To alleviate this problem, a customized consumable weld insert 20 is disclosed. The consumable weld insert 20 includes a pair of legs 21, 22 each having a distal end 23, 24 respectively that lead to proximal ends 25, 26 respectively. The proximal ends 25, 26 are joined together at a central portion 27 that connects the proximal ends 25, 26 of the legs 21, 22 to a root filler portion 28. The root filler portion 28 extends away from the central portion 27 and terminates at a proximal end 29.

The insert 20, although having a generally Y-shaped cross-sectional profile along the insert, does not have a consistent or uniform cross-sectional profile. Instead, the insert 20 is customized to accommodate for variations in the size or shape of the groove disposed between the edges 16, 17 of the base metal parts 15, 18. This is accomplished by first scanning the groove between the base metal parts 15, 18. The scanning may be performed with a laser. The scanning may be carried out to provide digital data regarding the three-dimensional shapes and sizes of the groove disposed between the base metal parts 15, 18. As indicated above, the groove may include variations in size and shape. Software may then be used to convert the digital data into a 3D model. As will be apparent to those skilled in the art, the 3D model may then be readily transmitted to a 3D printer. Also, as will be apparent to those skilled in the art, the digital data may be used by the 3D printer to print a customized consumable weld insert from metal powder as described above.

The consumable insert 20 may include filler material, or, the metal powder provided to the 3D printer may include filler material. The method may further include choosing the specific metal powder used by the 3D printer based upon the metallurgy of the base metal parts. As noted above, because access to the back side of the joint between the base metal parts 15, 18 is not always fully accessible, the customized consumable weld insert 20 is preferably of the Y-shape variety. However, despite being of a Y-shaped type, the customized consumable weld insert 20 does not have a consistent or uniform cross-sectional profile along the length of the insert 20.

As will be apparent to those skilled in the art, the converting of the digital data into 3D model may be performed with computer aided design (CAD) software. As an alternative, the converting of the digital data into the 3D model may be performed with animation software. Still further, the transmitting of the 3D model to the 3D printer may include formatting of the 3D model into a “.stl” format or other appropriate formats. The process carried out by the 3D printer during the printing of the customized consumable insert may be a selective laser sintering (SLS) process, electron beam melting (EBM) or another high energy beam additive manufacturing process.

In one aspect, the 3D printing may be characterized as depositing a first layer of metal powder onto a target surface, scanning a selective portion of the first layer with an energy beam to melt the selective portion of the first layer and allowing the selective portion to solidify, depositing a second layer of metal powder onto the first layer after the scanning of the first layer, scanning a selected portion of the second layer with the energy beam to melt the selective portion of the second layer onto the first layer, and repeating the depositing and scanning with subsequent layers until the customized consumable insert is formed. In a refinement, the energy beam may be a laser.

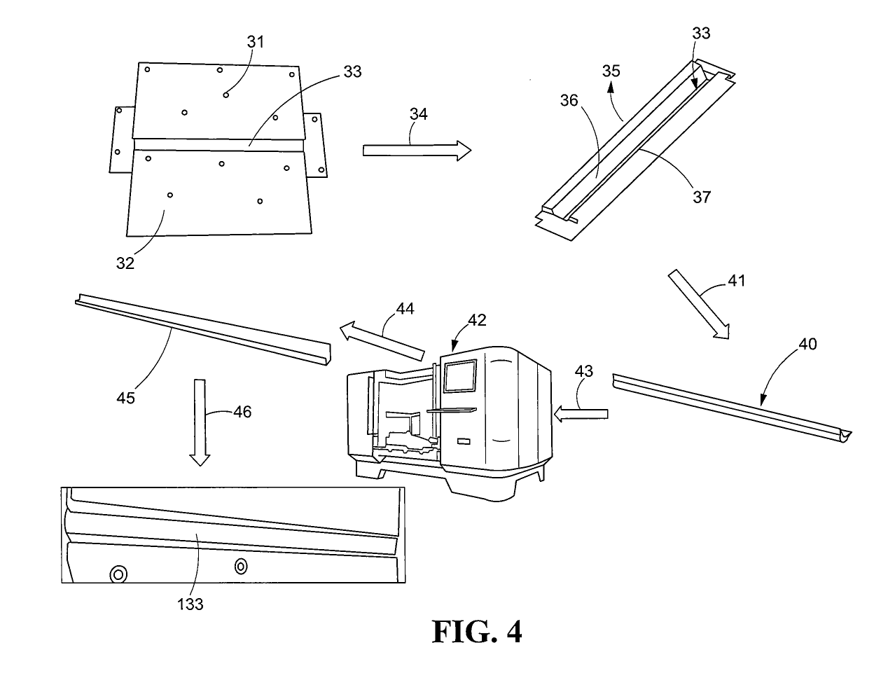

Turning to FIG. 4, one disclosed process is illustrated schematically. Two base metal parts 31, 32 are shown with a joint or gap 33 disposed therebetween, which needs to be welded. Initially, the joint 33 is scanned in part 34 to create a 3D model 35 of the joint 33 and the edges 36, 37 of the base metal parts 31, 32 respectively. The 3D model 35 of the joint 33 is then converted into a 3D model 40 of a consumable insert in part 41. The 3D model 40 is then transmitted to the 3D printer 42 in part 43 where it is “printed” in part 44 to produce the consumable insert 45. The consumable insert 45 may then be used to produce a properly welded joint 133 in part 46.

### INDUSTRIAL APPLICABILITY

The method of fabricating customized consumable weld inserts for use in forming a butt weld between two base metal parts is disclosed. The customized consumable weld insert accounts for variations in size and shape of the groove disposed between the two base metal parts to be joined. The two base metal parts may be arranged in an edge to edge fashion thereby forming the groove, although the groove is not in uniform and includes at least one variation. The groove may be scanned to provide digital data regarding the varying three-dimensional shape and size of the groove. The digital data may be converted to a 3D model which is transmitted to a 3D printer. The customized consumable insert may be printed by the 3D printer from metal powder. Thus, instead of a standard Y-shaped consumable weld insert that has a uniform cross-sectional profile, a customized consumable Y-shaped weld insert is provided that accounts for variations in shape and size along the groove.

A method of joining two base metal parts at a butt joint is also disclosed. The method may include aligning the two base metal parts in a coplanar fashion wherein edges of the two base metal parts face each other and form a groove between the edges. The groove may be non uniform in cross-sectional profile along the groove and may include at least one variation. The method may further include scanning the groove to provide digital data, converting the digital data into a 3D model of the groove and transmitting the 3D model to a 3D printer. The customized consumable insert may be printed from metal powder using the 3D printer based upon the 3D model. The customized consumable weld insert may then be placed in the groove and the two pieces may be welded together in a conventional manner but wherein the customized consumable weld insert avoids unnecessary mass accumulations or areas where an insufficient mass is provided as a result of variations in the size and shape of the groove along the weld joint. Finally, customized consumable weld inserts made in accordance with the foregoing are also provided.

While only certain embodiments have been set forth, alternatives and modifications will be apparent from the above description to those skilled in the art. These and other alternatives are considered equivalents and within the spirit and scope of this disclosure and the appended claims.

What is claimed:

1. A method of fabricating a customized consumable weld insert, the method comprising:
providing two base metal parts, each base metal part having at least one edge;
arranging the two base metal parts in an edge to edge configuration with a groove disposed between the two edges, the groove including at least one variation along the groove;
scanning the groove to provide digital data regarding three-dimensional (3D) shapes and sizes of the groove and the at least one variation;
converting the digital data into a 3D model;
transmitting the 3D model to a 3D printer; and
printing the customized consumable insert from metal powder with the 3D printer.

2. The method of claim 1 wherein the metal powder includes a filler material.

3. The method of claim 1 further including choosing the metal powder based on a metallurgy of the base metal parts.

4. The method of claim 1 wherein the customized consumable insert is of a Y-shaped type.

5. The method of claim 1 wherein the converting of the digital data into the 3D model is performed with computer aided design (CAD) software.

6. The method of claim 1 wherein the converting of the digital data into the 3D model is performed with animation software.

7. The method of claim 1 wherein the transmitting of the 3D model to the 3D printer includes formatting the 3D model into a .stl format.

8. The method of claim 1 wherein the scanning is performed with a laser.

9. The method of claim 1 wherein the 3D printer prints the customized consumable insert from metal powder using selective laser sintering (SLS) or electron beam melting (EBM).

10. The method of claim 1 wherein the at least one variation is selected from the group consisting of: at least one variation in size of the groove; at least one variation in shape of the groove; and combinations thereof.

11. The method of claim 1 wherein the printing of the customized consumable insert includes:
depositing a first layer of metal powder onto a target surface;
scanning a selected portion of the first layer with an energy beam to melt the selected portion of the first layer and allowing the selected portion to solidify,
depositing a second layer of metal powder onto the first layer after the scanning of the first layer;
scanning a selected portion of the second layer with the energy beam to melt the selected portion of the second layer onto the first layer, and
repeating the depositing and scanning with subsequent layers until the customized consumable insert is formed.

12. The method of claim 11 wherein the energy beam is a laser.

13. A method of joining two base metal parts at a butt joint, the method comprising:
aligning the two base metal parts in a coplanar fashion wherein edges of the two base metal parts face each other and form a groove between the edges, the groove being non-uniform in cross-section along the groove and including at least one variation;
scanning the groove with a scanner to provide digital data;
converting the digital data into a three-dimensional (3D) model of the groove;
transmitting the 3D model to a 3D printer,
printing the customized consumable insert from metal powder using the 3D printer, the insert being based on the 3D model;
placing the insert in the groove; and
welding the two base plates together at the groove to form a butt weld wherein the insert forms part of the butt weld.

14. The method of claim 13 wherein the metal powder includes a filler material.

15. The method of claim 13 further including choosing the metal powder based on a metallurgy of the base metal parts.

16. The method of claim 13 wherein the insert is of a Y-shaped type.

17. The method of claim 13 wherein the transmitting of the 3D model to the 3D printer includes formatting the 3D model into a .stl format.

18. The method of claim 13 wherein the scanning is performed with a laser.

19. The method of claim 13 wherein the 3D printer prints the customized consumable insert from the metal powder using selective laser sintering (SLS) or electron beam melting (EBM).

20. A customized consumable weld insert for joining two base metal parts at a butt weld, the insert comprising:
two legs, each leg including a distal end that leads to a proximal end, the proximal ends of the legs being joined together at a central portion;
the central portion being disposed between and connected to the proximal ends of the legs and a root filler portion, the root filler portion extending away from the central portion and the two legs and terminating at a proximal end;
the insert having a generally Y-shaped cross-sectional profile along the insert and wherein at least one cross-sectional dimension varies along the insert, the at least one cross-sectional dimension being selected from the group consisting of: a distance (D) between the distal ends of the legs; a height (H) between the distal ends of the legs and the proximate end of the root filler portion; and a maximum width (W) of the root filler portion.
